(19) United States
(12) Patent Application Publication
(10) Pub. No.: US 2025/0282548 A1
(43) Pub. Date: Sep. 11, 2025

(54) LOCAL POSITIONING SYSTEM FOR VEHICLES ON A GRID OF AN AUTOMATED STORAGE SYSTEM

(71) Applicant: AutoStore Technology AS, Nedre Vats (NO)

(72) Inventor: Eirik Selsaas, Aksdal (NO)

(21) Appl. No.: 18/861,334

(22) PCT Filed: Apr. 30, 2023
(86) PCT No.: PCT/EP2023/061421

§ 371 Date: Oct. 29, 2024

(30) Foreign Application Priority Data
May 3, 2022 (NO) 20220505

(51) Int. Cl. B65G 1/04; G01S 5/14

(52) U.S. Cl. CPC B65G 1/0492; B65G 1/0464; G01S 5/14

(57) ABSTRACT

System and method for calculating the physical positioning of a container handling vehicle on a grid of an automated storage and retrieval system. wherein the automated storage and retrieval system comprises a framework structure which includes a rail system comprising a first set of parallel rails arranged to guide movement of a container handling vehicle in a first direction across the top of the framework structure, and a second set of parallel rails arranged perpendicular to the first set of rails to guide movement of the container handling vehicle in a second direction which is perpendicular to the first direction. the first and second sets of parallel rails dividing the rail system into a plurality of grid cells. the framework structure comprising upright members defining storage columns for storing containers within the framework structure, wherein the automated storage and retrieval system comprises container handling vehicles configured to operate on the rail system, a wireless communication system for communicating instructions and information between the central computer system and the container handling vehicles and between the container handling vehicles, wherein the wireless communication system comprises a plurality of transceivers positioned at known locations (501) either on the grid or around the grid, and a transceiver positioned on an unknown position (503) on the grid and using a signal sent between the transceivers positioned at known locations (501) on the grid or around the grid and the transceiver positioned on an unknown position (503) on the grid for calculating the distance between the sender of a signal and the receiver of the signal.

### FIELD OF THE INVENTION

The present invention relates to an automated storage and retrieval system for storage and retrieval of containers, in particular a system and method for locating a lost container handling vehicle by triangulating the signal strength either sent or received by the lost container handling vehicle.

### BACKGROUND AND PRIOR ART

FIG. 1 discloses a typical prior art automated storage and retrieval system 1 with a framework structure 100 and FIGS. 2, 3 and 4 disclose three different prior art container handling vehicles 201,301,401 suitable for operating on such a system 1.

The framework structure 100 comprises upright members 102 and a storage volume comprising storage columns 105 arranged in rows between the upright members 102. In these storage columns 105 storage containers 106, also known as bins, are stacked one on top of one another to form stacks 107. The members 102 may typically be made of metal, e.g. extruded aluminum profiles.

The framework structure 100 of the automated storage and retrieval system 1 comprises a rail system 108 arranged across the top of framework structure 100, on which rail system 108 a plurality of container handling vehicles 201,301,401 may be operated to raise storage containers 106 from, and lower storage containers 106 into, the storage columns 105, and also to transport the storage containers 106 above the storage columns 105. The rail system 108 comprises a first set of parallel rails 110 arranged to guide movement of the container handling vehicles 201,301,401 in a first direction X across the top of the frame structure 100, and a second set of parallel rails 111 arranged perpendicular to the first set of rails 110 to guide movement of the container handling vehicles 201,301,401 in a second direction Y which is perpendicular to the first direction X. Containers 106 stored in the columns 105 are accessed by the container handling vehicles 201,301,401 through access openings 112 in the rail system 108. The container handling vehicles 201,301,401 can move laterally above the storage columns 105, i.e. in a plane which is parallel to the horizontal X-Y plane.

The upright members 102 of the framework structure 100 may be used to guide the storage containers during raising of the containers out from and lowering of the containers into the columns 105. The stacks 107 of containers 106 are typically self-supportive.

Each prior art container handling vehicle 201,301,401 comprises a vehicle body 201a, 301a, 401a and first and second sets of wheels 201b,301b,201c,301c, 401b,401c which enable the lateral movement of the container handling vehicles 201,301,401 in the X direction and in the Y direction, respectively. In FIGS. 2, 3 and 4 two wheels in each set are fully visible. The first set of wheels 201b,301b,401b is arranged to engage with two adjacent rails of the first set 110 of rails, and the second set of wheels 201c, 301c,401c is arranged to engage with two adjacent rails of the second set 111 of rails. At least one of the sets of wheels 201b, 301b, 201c, 301c, 401b,401c can be lifted and lowered, so that the first set of wheels 201b, 301b,401b and/or the second set of wheels 201c,301c,401c can be engaged with the respective set of rails 110, 111 at any one time.

Each prior art container handling vehicle 201,301,401 also comprises a lifting device for vertical transportation of storage containers 106, e.g. raising a storage container 106 from, and lowering a storage container 106 into, a storage column 105. The lifting device comprises one or more gripping/engaging devices which are adapted to engage a storage container 106, and which gripping/engaging devices can be lowered from the vehicle 201,301,401 so that the position of the gripping/engaging devices with respect to the vehicle 201,301,401 can be adjusted in a third direction Z which is orthogonal the first direction X and the second direction Y. Parts of the gripping device of the container handling vehicles 301,401 are shown in FIGS. 3 and 4 indicated with reference number 304,404. The gripping device of the container handling device 201 is located within the vehicle body 201a in FIG. 2.

Conventionally, and also for the purpose of this application, Z=1 identifies the uppermost layer of storage containers, i.e. the layer immediately below the rail system 108, Z=2 the second layer below the rail system 108, Z=3 the third layer etc. In the exemplary prior art disclosed in FIG. 1, Z=8 identifies the lowermost, bottom layer of storage containers. Similarly, X=1 . . . n and Y=1 . . . n identifies the position of each storage column 105 in the horizontal plane. Consequently, as an example, and using the Cartesian coordinate system X, Y, Z indicated in FIG. 1, the storage container identified as 106′ in FIG. 1 can be said to occupy storage position X=10, Y=2, Z=3. The container handling vehicles 201,301,401 can be said to travel in layer Z=0, and each storage column 105 can be identified by its X and Y coordinates. Thus, the storage containers shown in FIG. 1 extending above the rail system 108 are also said to be arranged in layer Z=0.

The storage volume of the framework structure 100 has often been referred to as a grid 104, where the possible storage positions within this grid are referred to as storage cells. Each storage column may be identified by a position in an X- and Y-direction, while each storage cell may be identified by a container number in the X-, Y- and Z-direction.

Each prior art container handling vehicle 201,301,401 comprises a storage compartment or space for receiving and stowing a storage container 106 when transporting the storage container 106 across the rail system 108. The storage space may comprise a cavity arranged internally within the vehicle body 201a as shown in FIGS. 2 and 4 and as described in e.g. WO2015/193278A1 and WO2019/206487A1.

FIG. 3 shows an alternative configuration of a container handling vehicle 301 with a cantilever construction. Such a vehicle is described in detail in e.g. NO317366.

The cavity container handling vehicles 201 shown in FIG. 2 may have a footprint that covers an area with dimensions in the X and Y directions which is generally equal to the lateral extent of a storage column 105, e.g. as is described in WO2015/193278A1. The term ‘lateral’ used herein may mean ‘horizontal’.

Alternatively, the cavity container handling vehicles 401 may have a footprint which is larger than the lateral area defined by a storage column 105 as shown in FIGS. 1 and 4, e.g. as is disclosed in WO2014/090684A1 or WO2019/206487A1.

The rail system 108 typically comprises rails with grooves in which the wheels of the vehicles run. Alternatively, the rails may comprise upwardly protruding elements, where the wheels of the vehicles comprise flanges to prevent derailing. These grooves and upwardly protruding elements are collectively known as tracks. Each rail may comprise one track, or each rail may comprise two parallel tracks.

WO2018/146304A1, the contents of which are incorporated herein by reference, illustrates a typical configuration of rail system 108 comprising rails and parallel tracks in both X and Y directions.

In the framework structure 100, a majority of the columns 105 are storage columns 105, i.e. columns 105 where storage containers 106 are stored in stacks 107. However, some columns 105 may have other purposes. In FIG. 1, columns 119 and 120 are such special-purpose columns used by the container handling vehicles 201,301,401 to drop off and/or pick up storage containers 106 so that they can be transported to an access station (not shown) where the storage containers 106 can be accessed from outside of the framework structure 100 or transferred out of or into the framework structure 100. Within the art, such a location is normally referred to as a ‘port’ and the column in which the port is located may be referred to as a ‘port column’ 119, 120. The transportation to the access station may be in any direction, that is horizontal, tilted and/or vertical. For example, the storage containers 106 may be placed in a random or dedicated column 105 within the framework structure 100, then picked up by any container handling vehicle and transported to a port column 119,120 for further transportation to an access station. Note that the term ‘tilted’ means transportation of storage containers 106 having a general transportation orientation somewhere between horizontal and vertical.

In FIG. 1, the first port column 119 may for example be a dedicated drop-off port column where the container handling vehicles 201,301 can drop off storage containers 106 to be transported to an access or a transfer station, and the second port column 120 may be a dedicated pick-up port column where the container handling vehicles 201,301,401 can pick up storage containers 106 that have been transported from an access or a transfer station.

The access station may typically be a picking or a stocking station where product items are removed from or positioned into the storage containers 106. In a picking or a stocking station, the storage containers 106 are normally not removed from the automated storage and retrieval system 1, but are returned into the framework structure 100 again once accessed. A port can also be used for transferring storage containers to another storage facility (e.g. to another framework structure or to another automated storage and retrieval system), to a transport vehicle (e.g. a train or a lorry), or to a production facility.

A conveyor system comprising conveyors is normally employed to transport the storage containers between the port columns 119,120 and the access station.

If the port columns 119,120 and the access station are located at different levels, the conveyor system may comprise a lift device with a vertical component for transporting the storage containers 106 vertically between the port column 119,120 and the access station.

The conveyor system may be arranged to transfer storage containers 106 between different framework structures, e.g. as is described in WO2014/075937A1, the contents of which are incorporated herein by reference.

When a storage container 106 stored in one of the columns 105 disclosed in FIG. 1 is to be accessed, one of the container handling vehicles 201,301,401 is instructed to retrieve the target storage container 106 from its position and transport it to the drop-off port column 119. This operation involves moving the container handling vehicle 201,301 to a location above the storage column 105 in which the target storage container 106 is positioned, retrieving the storage container 106 from the storage column 105 using the container handling vehicle's 201,301,401 lifting device (not shown), and transporting the storage container 106 to the drop-off port column 119. If the target storage container 106 is located deep within a stack 107, i.e. with one or a plurality of other storage containers 106 positioned above the target storage container 106, the operation also involves temporarily moving the above-positioned storage containers prior to lifting the target storage container 106 from the storage column 105. This step, which is sometimes referred to as “digging” within the art, may be performed with the same container handling vehicle that is subsequently used for transporting the target storage container to the drop-off port column 119, or with one or a plurality of other cooperating container handling vehicles. Alternatively, or in addition, the automated storage and retrieval system 1 may have container handling vehicles 201,301,401 specifically dedicated to the task of temporarily removing storage containers 106 from a storage column 105. Once the target storage container 106 has been removed from the storage column 105, the temporarily removed storage containers 106 can be repositioned into the original storage column 105. However, the removed storage containers 106 may alternatively be relocated to other storage columns 105.

When a storage container 106 is to be stored in one of the columns 105, one of the container handling vehicles 201,301,401 is instructed to pick up the storage container 106 from the pick-up port column 120 and transport it to a location above the storage column 105 where it is to be stored. After any storage containers 106 positioned at or above the target position within the stack 107 have been removed, the container handling vehicle 201,301,401 positions the storage container 106 at the desired position. The removed storage containers 106 may then be lowered back into the storage column 105, or relocated to other storage columns 105.

For monitoring and controlling the automated storage and retrieval system 1, e.g. monitoring and controlling the location of respective storage containers 106 within the framework structure 100, the content of each storage container 106; and the movement of the container handling vehicles 201,301,401 so that a desired storage container 106 can be delivered to the desired location at the desired time without the container handling vehicles 201,301,401 colliding with each other, the automated storage and retrieval system 1 comprises a control system 500 which typically is computerized and which typically comprises a database for keeping track of the storage containers 106.

There are several reasons for a container handling container handling vehicle breaking down on the grid. One is user errors where users manually move container handling vehicles either physically or logically with the result that the logical position no longer matches the actual position. This is a common cause of container handling vehicle crashes. Also, container handling vehicle errors where the container handling vehicle no longer can establish its whereabouts on the grid. E.g. belt ruptures or other issues. This also causes crashes because we only block the area where the system thinks the container handling vehicle logically is.

WO2019238697A1 describes a storage system provided with a transfer section at the lower level of the storage system with container transfer vehicles operating on the floor of the transfer floor to carry and transfer storage containers from the storage system to a second location outside the storage system. The system employs a guidance system for guiding the container transfer vehicles on the floor.

EP3081511A2 relates autonomous transport vehicle in a warehouse facility. A vertical lift with shelf and support fingers is provided. The vehicle is provided with sensors and support arms that align along the shelves to determine the location of the vehicle.

US 2018143312A1 relates to determining the position of an autonomous vehicle in a building based on ultra-wideband signals transmitted and received by the vehicle.

US2020104790A1 describes a warehouse facility with sensor equipment provided with RFID tags for tracking containers. Also, described is geo-tagged identification data of carrier vehicles operating in the facility to record arrival times of the carrier vehicles.

There is currently a delay from when a container handling vehicle is out of position until the system is able to understand it and stop other container handling vehicles from getting too close to this container handling vehicle.

At the moment the most used solution for locating a lost container handling vehicle is shutting down the entire grid while a person maneuver onto the grid and locates and moves the lost container handling vehicle. This solution is costly and time consuming and dangerous for the person maneuvering on the grid.

### SUMMARY OF THE INVENTION

The present invention is set forth and characterized in the independent claims, while the dependent claims describe other characteristics of the invention. In one aspect, the invention is related to a system for calculating the physical positioning of a container handling vehicle on a grid of an automated storage and retrieval system, wherein the automated storage and retrieval system comprises a framework structure which includes a rail system comprising a first set of parallel rails arranged to guide movement of a container handling vehicle in a first direction (X) across the top of the framework structure, and a second set of parallel rails arranged perpendicular to the first set of rails to guide movement of the container handling vehicle in a second direction (Y) which is perpendicular to the first direction (X), the first and second sets of parallel rails dividing the rail system into a plurality of grid cells, the framework structure comprising upright members defining storage columns for storing containers within the framework structure, wherein the automated storage and retrieval system comprises container handling vehicles configured to operate on the rail system, a wireless communication system for communicating instructions and information between the central computer system and the container handling vehicles and between the container handling vehicles, wherein the wireless communication system comprises a plurality of transceivers positioned at known locations either on the grid or around the grid, and a transceiver positioned on an unknown position on the grid and using a signal sent between the transceivers positioned at known locations on the grid or around the grid and the transceiver positioned on an unknown position on the grid for calculating the distance between the sender of a signal and the receiver of the signal.

The transceivers can be positioned at known locations either on the grid or around the grid are access points in a wireless communication system, the transceivers positioned at known locations either on the grid or around the grid can be the wireless communication equipment on container handling vehicles.

The sender of the signal can be the transceiver positioned on an unknown position on the grid and the receiver of the signal can be the plurality of transceivers positioned at known locations either on the grid or around the grid, also the sender of the signal can be the plurality of transceivers positioned at known locations either on the grid or around the grid and the receiver of the signal can be the transceiver positioned on an unknown position on the grid.

The wireless communication system can be a Wi-Fi network, further, the receiver of the signal can measure the Received Signal Strength Indicator (RSSI) for calculating the distance to the sender of the signal. the sender of the signal does sweeps with different signal strengths. The signal is in the form of a message stating the strength of the signal. The transceivers can be transmitters and receivers of laser light, also the transceivers can be transmitters and receivers of ultrasound signals. The wireless communication system can be a short range radio communication system.

In a second aspect, the invention concerns a method for calculating the physical positioning of a container handling vehicle on a grid of an automated storage and retrieval system wherein the automated storage and retrieval system comprises a framework structure which includes a rail system comprising a first set of parallel rails arranged to guide movement of a container handling vehicle in a first direction (X) across the top of the framework structure, and a second set of parallel rails arranged perpendicular to the first set of rails to guide movement of the container handling vehicle in a second direction (Y) which is perpendicular to the first direction (X), the first and second sets of parallel rails dividing the rail system into a plurality of grid cells, the framework structure comprising upright members defining storage columns for storing containers within the framework structure, wherein the automated storage and retrieval system comprises at least one container handling vehicle configured to operate on the rail system a wireless communication system for communicating instructions and information between the central computer system and the container handling vehicles and between the container handling vehicles wherein the method comprises the following steps: using the transceivers at a known location on the grid or around the grid to either send or receive a signal of known strength, using a transceiver at an unknown location on the grid to either receive or send the signal of known strength, measuring the strength of the received signal to calculate the distance to the sender, and using the measurements of a plurality of distance calculations to determine the position of the transceiver at an unknown location on the grid.

The transmitter can send sweeps of signals with different signal strengths.

Also, sending the signal from the transceiver positioned on an unknown position on the grid and receiving the signal on the plurality of transceivers positioned at known locations either on the grid or around the grid.

Further, sending the signal from the plurality of transceivers positioned at known locations either on the grid or around the grid and receiving the signal on the transceiver positioned on an unknown position on the grid.

Also, the system can use the measured Received Signal Strength Indicator (RSSI) for calculating the distance to the sender of the signal.

By using this system and method, the lost container handling vehicle can be located quickly, without having to shut down large part of the grid and most importantly without endangering the health of any personnel.

### BRIEF DESCRIPTION OF THE DRAWINGS

Following drawings are appended to facilitate the understanding of the invention. The drawings show embodiments of the invention, which will now be described by way of example only, where:

FIG. 1 is a perspective view of a framework structure of a prior art automated storage and retrieval system.

FIG. 2 is a perspective view of a prior art container handling vehicle having an internally arranged cavity for carrying storage containers therein.

FIG. 3 is a perspective view of a prior art container handling vehicle having a cantilever for carrying storage containers underneath.

FIG. 4 is a perspective drawing of a container handling vehicle with a central cavity solution.

FIG. 5 shows a scenario where a user has collected the wrong container handling vehicle back to the service area.

FIG. 6 is a scenario where the user has placed the container handling vehicle one cell wrong.

FIG. 7 is a scenario where e.g. a drive belt has broken on a container handling vehicle which results in it using a much longer braking distance than anticipated and ends up in the wrong place and in the way of another container handling vehicle.

### DETAILED DESCRIPTION OF THE INVENTION

In the following, embodiments of the invention will be discussed in more detail with reference to the appended drawings. It should be understood, however, that the drawings are not intended to limit the invention to the subject-matter depicted in the drawings.

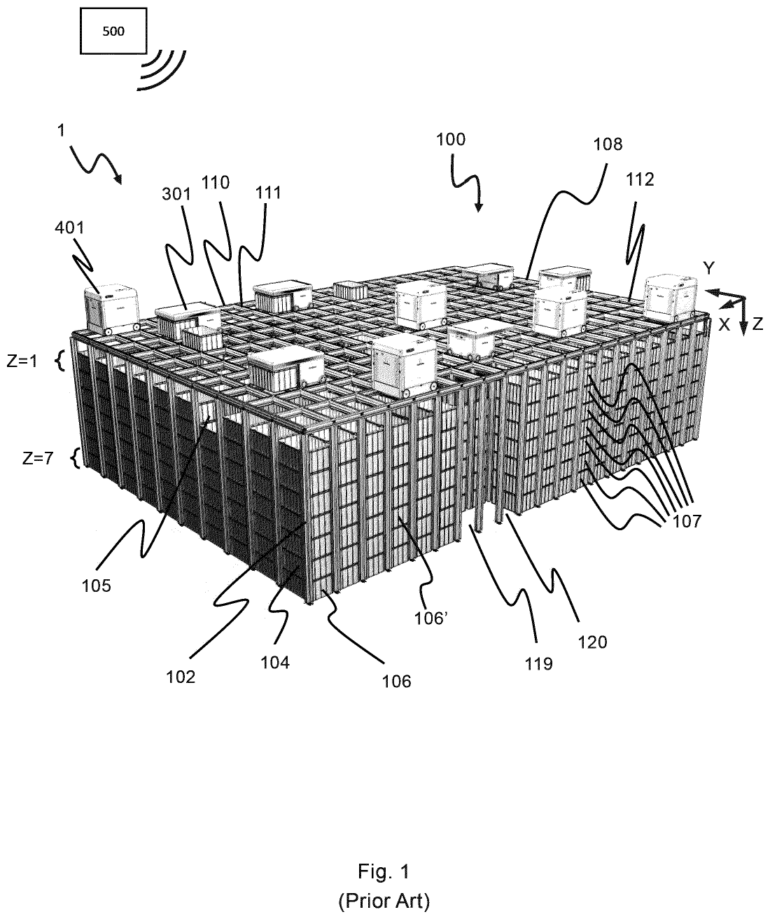

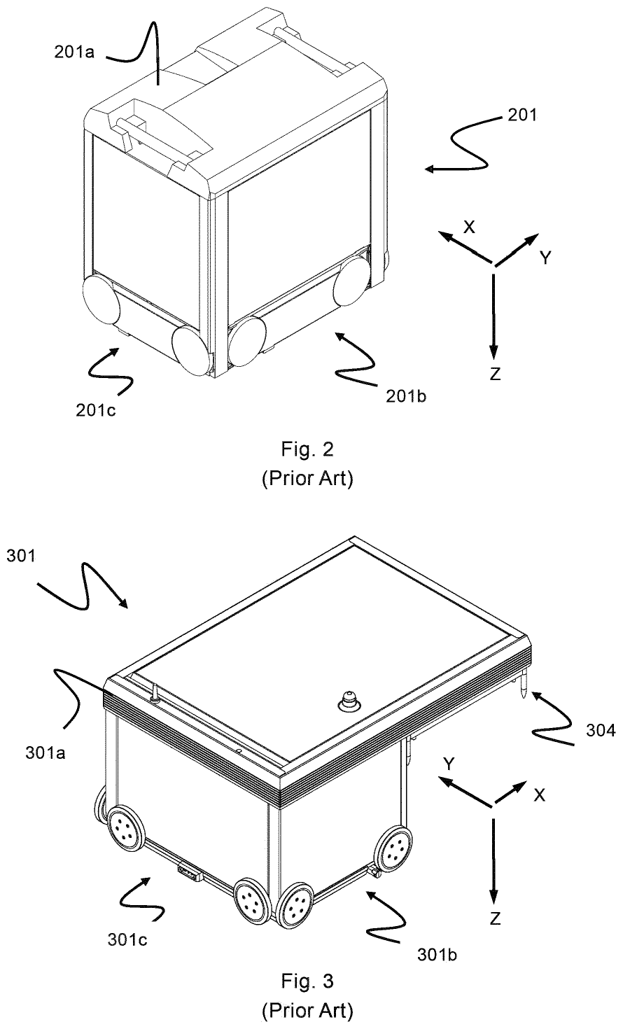

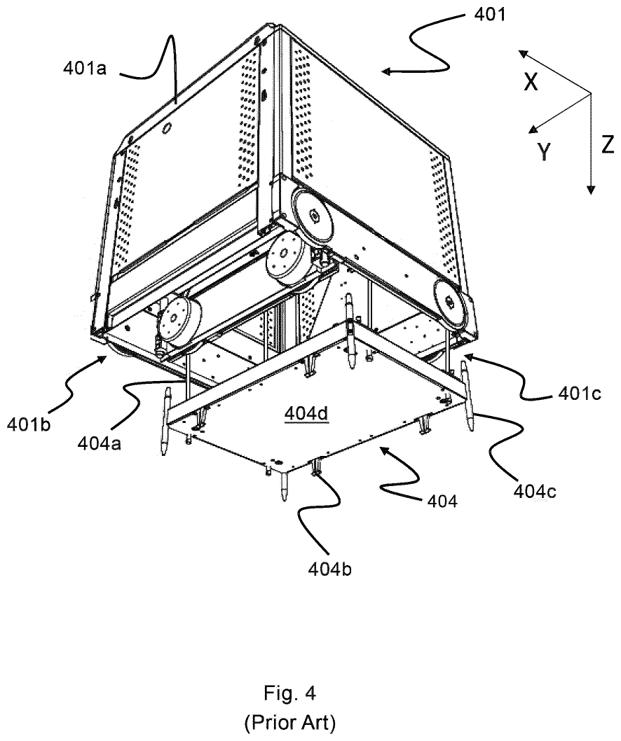

The framework structure 100 of the automated storage and retrieval system 1 is constructed in accordance with the prior art framework structure 100 described above in connection with FIGS. 1-3, i.e. a number of upright members 102 and a number of horizontal members 103, which are supported by the upright members 102, and further that the framework structure 100 comprises a first, upper rail system 108 in the X direction and Y direction.

The framework structure 100 further comprises storage compartments in the form of storage columns 105 provided between the members 102, 103, where storage containers 106 are stackable in stacks 107 within the storage columns 105.

The framework structure 100 can be of any size. In particular it is understood that the framework structure can be considerably wider and/or longer and/or deeper than disclosed in FIG. 1. For example, the framework structure 100 may have a horizontal extent of more than 700×700 columns and a storage depth of more than twelve containers.

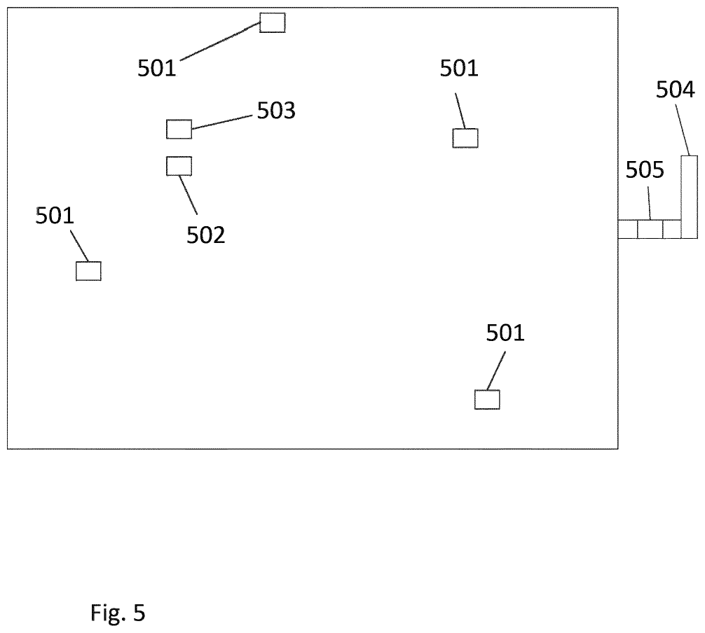

One embodiment of the automated storage and retrieval system according to the invention will now be discussed in more detail with reference to FIGS. 5-7

FIG. 5 shows an example of a scenario where a user has collected the wrong container handling vehicle back to the service area.

In this scenario a first container handling vehicle has broken down on the grid of the storage and retrieval system. The entire storage and retrieval system has to be shut down in order to make it safe for a person to go out on the grid and collect the broken down first container handling vehicle to a service area that is located in relation to the grid. However, the person that is to collect the broken down first container handling vehicle makes a mistake and collects a different second container handling vehicle back to the service area. When the storage and retrieval system is turned back up again the second container handling vehicle and the system is not aware that the second container handling vehicle has changed its position.

The user starts system. the second container handling vehicle would then, when the system is started up again, start driving in service area causing a possible dangerous event to both container handling vehicle and personnel. The present invention, in the form of a local positioning system that checked the position of the container handling vehicles when starting system, would prevent these problems from occurring.

In a preferred embodiment of the present invention the system uses the radio communication the system uses to communicate information between the parts of the storage and retrieval system and the central computer system. This radio system would use the RSSI (signal strength) between the objects because of the fact that this value will have a correlation to the distance between the objects.

In order to increase the accuracy, one would also do sweeps of the signal strength sent out. An example would be to send out 3 messages either from the object to detect or the object that aids in the detection:

Message 1: I am now sending at X watt

Message 2: I am now sending at Y watt

Message 3: I am now sending at Z watt

The receiver could then use this to better estimate the distance this message is being sent over.

For the storage and retrieval system used in this solution the known positioned objects are not limited to the access points 501. In principle all container handling vehicles on the grid has very accurate positions, and they are equipped with the same radio equipment as the access points 501. Therefore, the container handling vehicle with known positions can be actively used to aid in determining position of a container handling vehicle that we do not know the position of.

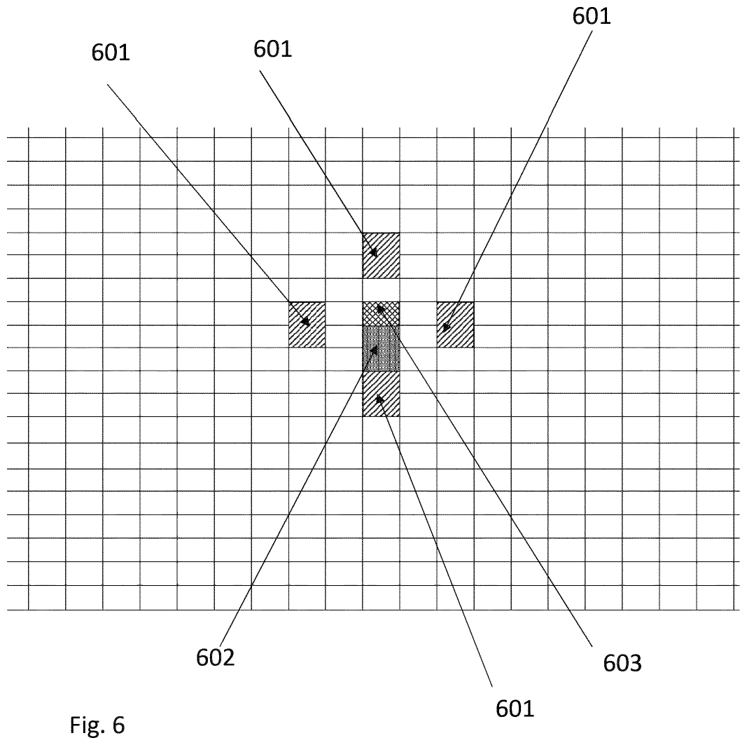

FIG. 6 is an example of a scenario where the user has placed the container handling vehicle one cell wrong. In cases where a first container handling vehicle is placed 1 cell wrong, it might be necessary to perform an extra step in order to locate the misplaced first container handling vehicle accurately.

In this figure the container handling vehicle should be occupying the cell 603 but is placed 1 cell off. The other container handling vehicles detect that the first container handling vehicle is placed wrong, but that the local positioning system is not able to detect accurately the physical position of the first container handling vehicle.

If the local positioning system detects that a first container handling vehicle is misplaced, it might not be able to detect the accurate position of the misplaced first container handling vehicle. The local positioning system then has to perform a second step in order to accurately detect its position.

The second step is to create a routine for other container handling vehicles to get within a given distance to the container handling vehicle and perform a positioning before the container handling vehicle is allowed to be under system control.

In this example the task is performed by using four container handling vehicles. However, in this example this could also be done with 1 container handling vehicle to reduce the error caused by differences between radios, and also this would occupy a smaller number of container handling vehicle for this task.

When the other container handling vehicles are placed at the given distance from the misplaced first container handling vehicles and performs an additional round of measurements by sending at least one radio signal that can be picked up by the receiver and used to calculate the distance the signal has traveled.

The transmitters can be either the other container handling vehicles that is positioned around the first misplaced container handling vehicle, and the receiver is the misplaced first container handling vehicle. But the transmitter can also be the misplaced container handling vehicle and the receivers can be the other container handling vehicles.

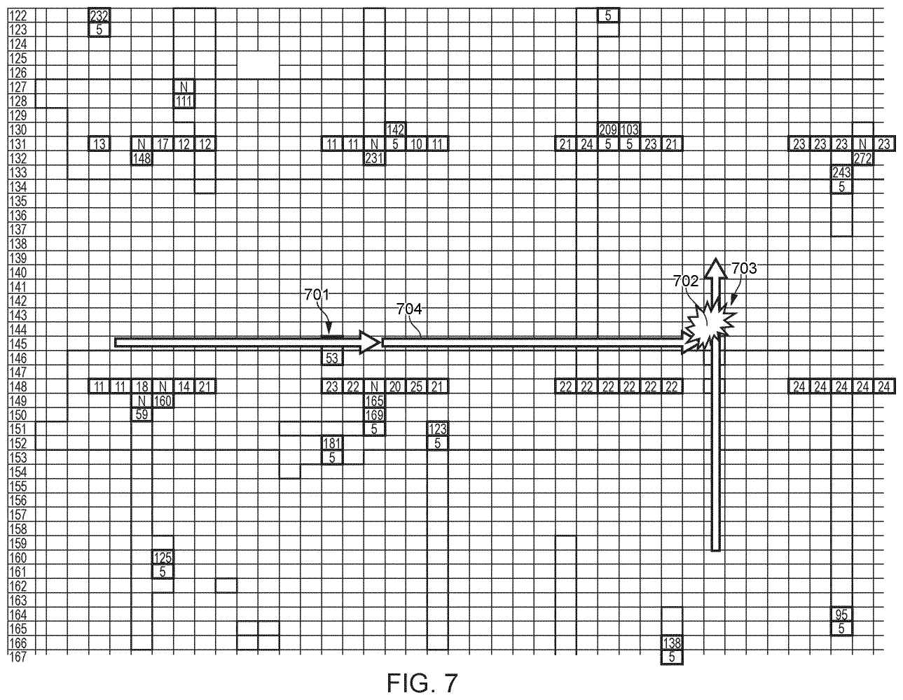

FIG. 7 is a scenario where e.g. a drive belt has broken on a container handling vehicle which results in it using a much longer braking distance than anticipated and ends up in the wrong place and in the way of another container handling vehicle.

With current state, when a first container handling vehicle has issues and the position is not certain we are using 2 options:

1. Stop system

2. Temporarily block the area that it is most probable that the container handling vehicle is at while the first container handling vehicle handles this error while keeping system running

The second alternative is becoming the desired one, because it will increase the uptime of the whole system, which again is critical to be able to have very large systems with many container handling vehicles.

This invention could be used to get a good definition of the area that needs to be blocked quick while keeping the system running. As an example, where this would have been a benefit, is if the container handling vehicle had a snapped belt and thus travelled far out of its logical position. The system tries to estimate the position of the container handling vehicle, but was way off, and this resulted in a crash and following downtime for the installation.

For this example the first misplaced container handling vehicle had an error when driving right that was caused by the driving belt snapping off, which resulted in the container handling vehicle not being able to break, and then ended up 18 cells off its logical position. The yellow cells are the cells that the system estimated the container handling vehicle to possibly be in and were thus the only ones blocked for traffic.

With the local positioning system this situation could have been prevented in 2 possible ways:

1: estimation of position and thus defining the blocked area

2: a warning signal being sent out from the affected container handling vehicles. And that any container handling vehicle that gets this signal stronger than expected would perform a stop or a rerouting around.

In the preceding description, various aspects of the delivery vehicle and the automated storage and retrieval system according to the invention have been described with reference to the illustrative embodiment. For purposes of explanation, specific numbers, systems and configurations were set forth in order to provide a thorough understanding of the system and its workings. However, this description is not intended to be construed in a limiting sense. Various modifications and variations of the illustrative embodiment, as well as other embodiments of the system, which are apparent to persons skilled in the art to which the disclosed subject matter pertains, are deemed to lie within the scope of the present claims.

Although we have focused on the signal strength as the way of calculating the distance to the broken down container handling vehicle the invention does not have to be limited to this technical feature. It is also possible to use the direction of the signal to calculate the distance to the broken down container handling vehicle.

Further, it is also possible to use the delay of the signal to calculate the distance to the broken down container handling vehicle.

### LIST OF REFERENCE NUMBERS

### Prior Art (FIGS. 1-4)

1 Prior art automated storage and retrieval system
100 Framework structure
102 Upright members of framework structure
103 Horizontal members of framework structure
104 Storage grid
105 Storage column
106 Storage container
106′ Particular position of storage container
107 Stack
108 Rail system
110 Parallel rails in first direction (X)
110a First rail in first direction (X)
110b Second rail in first direction (X)
111 Parallel rail in second direction (Y)
111a First rail of second direction (Y)
111b Second rail of second direction (Y)
112 Access opening
119 First port column
120 Second port column
201 Prior art container handling vehicle
201a Vehicle body of the container handling vehicle 201
201b Drive means/wheel arrangement, first direction (X)
201c Drive means/wheel arrangement, second direction (Y)
301 Prior art cantilever container handling vehicle
301a Vehicle body of the container handling vehicle 301
301b Drive means in first direction (X)
301c Drive means in second direction (Y)
401 Prior art container handling vehicle
401a Vehicle body of the container handling vehicle 401
401b Drive means in first direction (X)
401c Drive means in second direction (Y)
501 Access point
502 Logical position of misplaced container handling vehicle
503 Physical position of a broken down container handling vehicle.
504 Service area
505 Physical position of misplaced container handling vehicle/Logical position of broken down container handling vehicle
601 Access points
602 Physical position of a misplaced container handling vehicle.
603 A cell the container handling vehicle 602 should be covering.
701 Estimated position of a broken container handling vehicle
702 Physical position of the broken container handling vehicle.
703 Traveling direction of a container handling vehicle on the grid.
704 Traveling direction of the broken container handling vehicle.
X First Direction
Y Second direction
Z Third direction

1. System for calculating the physical positioning of a container handling vehicle on a grid of an automated storage and retrieval system, wherein the automated storage and retrieval system comprises a framework structure which includes a rail system comprising a first set of parallel rails arranged to guide movement of a container handling vehicle in a first direction across the top of the framework structure, and a second set of parallel rails arranged perpendicular to the first set of rails to guide movement of the container handling vehicle in a second direction which is perpendicular to the first direction, the first and second sets of parallel rails dividing the rail system into a plurality of grid cells, the framework structure comprising upright members defining storage columns for storing containers within the framework structure, wherein the automated storage and retrieval system comprises container handling vehicles configured to operate on the rail system, a wireless communication system for communicating instructions and information between the central computer system and the container handling vehicles and between the container handling vehicles, characterized in that the wireless communication system comprises a plurality of transceivers positioned at known locations either on the grid or around the grid, and a transceiver positioned on an unknown position on the grid and using a signal sent between the transceivers positioned at known locations on the grid or around the grid and the transceiver positioned on an unknown position on the grid for calculating the distance between the sender of a signal and the receiver of the signal.

2. A system according to claim 1 wherein the transceivers positioned at known locations either on the grid or around the grid are access points in a wireless communication system.

3. A system according to claim 1 wherein the transceivers positioned at known locations either on the grid or around the grid are the wireless communication equipment on container handling vehicles.

4. A system according to claim 1 wherein the sender of the signal is the transceiver positioned on an unknown position on the grid and the receiver of the signal is the plurality of transceivers positioned at known locations either on the grid or around the grid.

5. A system according to claim 1 wherein the sender of the signal is the plurality of transceivers positioned at known locations either on the grid or around the grid and the receiver of the signal is the transceiver positioned on an unknown position on the grid.

6. A system according to claim 1 wherein the wireless communication system is a Wi-Fi network

7. A system according to claim 1 wherein the receiver of the signal measures the Received Signal Strength Indicator (RSSI) for calculating the distance to the sender of the signal.

8. A system according to claim 1 wherein, the sender of the signal does sweeps with different signal strengths.

9. A system according to claim 1 wherein the signal is in the form of a message stating the strength of the signal.

10. A system according to claim 1 wherein the transceivers are transmitters and receivers of laser light.

11. A system according to claim 1 wherein the transceivers are transmitters and receivers of ultrasound signals.

12. A system according to claim 1 wherein the wireless communication system is a short range radio communication system.

13. Method for calculating the physical positioning of a container handling vehicle on a grid of an automated storage and retrieval system wherein the automated storage and retrieval system comprises a framework structure which includes a rail system comprising a first set of parallel rails arranged to guide movement of a container handling vehicle in a first direction across the top of the framework structure, and a second set of parallel rails arranged perpendicular to the first set of rails to guide movement of the container handling vehicle in a second direction which is perpendicular to the first direction, the first and second sets of parallel rails dividing the rail system into a plurality of grid cells, the framework structure comprising upright members defining storage columns for storing containers within the framework structure, wherein the automated storage and retrieval system comprises at least one container handling vehicle configured to operate on the rail system a wireless communication system for communicating instructions and information between the central computer system and the container handling vehicles and between the container handling vehicles wherein the method comprises the following steps:
using the transceivers at a known location on the grid or around the grid to either send or receive a signal of known strength,
using a transceiver at an unknown location on the grid to either receive or send the signal of known strength,
measuring the strength of the received signal to calculate the distance to the sender, using the measurements of a plurality of distance calculations to determine the position of the transceiver at an unknown location on the grid.

14. A method according to claim 13 wherein sending sweeps of signals with different signal strengths.

15. A method according to claim 13 wherein sending the signal from the transceiver positioned on an unknown position on the grid and receiving the signal on the plurality of transceivers positioned at known locations either on the grid or around the grid.

16. A method according to claim 13 wherein sending the signal from the plurality of transceivers positioned at known locations either on the grid or around the grid and receiving the signal on the transceiver positioned on an unknown position on the grid.

17. A method according to claim 13 wherein using the measured Received Signal Strength Indicator (RSSI) for calculating the distance to the sender of the signal.
